(19) United States
(12) Patent Application Publication
(10) Pub. No.: US 2011/0019891 A1
(43) Pub. Date: Jan. 27, 2011

(54) MEDICAL IMAGING PROCESS FOR TRIPLE-ENERGY MODELING, AND DEVICE FOR IMPLEMENTING SUCH A PROCESS

(76) Inventors: Sylvie Puong, Buc (FR); Serge Muller, Guyancourt (FR); Razvan Iordache, Paris (FR); Xavíer Bouchevreau, Doha (QA)

Correspondence Address: General Electric Company;GE Global Patent Operation, 2 Corporate Drive, Suite 648, Shelton, CT, 06484, US

(21) Appl. No.: 12/839,436

(22) Filed: Jul. 20, 2010

(30) Foreign Application Priority Data
Jul. 27, 2009 (FR) 0955250

(51) Int. Cl. G06K 9/00

(52) U.S. Cl. 382/131

(57) ABSTRACT

A method for X-ray imaging of a body using an imaging device comprising an image sensor and an X-ray emitter which operates at different emission spectra, wherein the method includes: acquiring a first image resulting from the passage through the body of X-rays emitted by the X-ray emitter with a first emission spectrum; calculating characteristics of the body on the basis of the first image, and calculating a second and a third emission spectrum based on the characteristics of the body, wherein the first, second and third emission spectra are distinct from one another; acquiring a second and third image resulting from the passage through the body of X-rays emitted by the X-ray emitter with the second and third emission spectrum respectively; and modeling the body by generating thickness charts for different materials comprising the body on the basis of the three images.

### CROSS-REFERENCE TO RELATED APPLICATIONS

This application claims priority under 35 U.S.C. §119(a)-(d) or (f) to prior-filed, co-pending French patent application serial number 0955250, filed on Jul. 27, 2009, which is hereby incorporated by reference in its entirety.

### BACKGROUND OF THE INVENTION

1. Field of Invention

The invention relates to the field of body imaging using X-rays.

The invention can be applied more specifically to the field of mammography.

2. Description of the Prior Art

Conventional mammography imaging consists of acquiring an image of a breast by means of emitting X-rays emitted in a given energy spectrum, i.e. morphological imaging.

New techniques, namely the time-based method and the multi-energy method, are used for imaging of tumor vascularization. These new techniques are not however used clinically.

In the context of these methods (time-based method or multi-energy method), it is preferable, even necessary, to use a contrast product, i.e. a product that will be injected into the body of the subject, and which has properties enabling it to be visible on the images acquired.

In particular, iodine in an injectable form is commonly used as a contrast agent, owing to its high X-ray opacity. The reason for this opacity is that the k-edge energy level of iodine, which corresponds to an energy level at which a photon absorption peak is observed, is in the range of the energy levels used or capable of being produced in the emission of X-rays in X-ray imaging.

The time-based method consists of acquiring a plurality of images of the body to be observed; a first image is taken before the injection of a contrast product (pre-injection image), and a series of images is taken after injection of a contrast product (post-injection images). A subtraction is then performed between the post-injection and pre-injection images, so as to obtain a final view of the body to be observed.

In conventional mammography, a so-called pre-exposure image can be used, which consists of an image taken with a very low dose, and which is useful in that it enables one to determine the emission parameters to be used for the image capture used directly to obtain the final image.

The aforementioned emission parameters, defining the X-ray spectrum, are indeed dependent on unknowns corresponding to measurement characteristics such as the thickness (in mammography: the thickness of the breast) and the composition (for example the glandularity in the case of mammography) of the body to be observed.

The determination of these parameters is detailed in “Dose to Population as a Metric in the Design of Optimised Exposure Control in Digital Mammography” R. Klausz and N. Shramchenko, Radiation Protection Dosimetry (2005), vol. 114, pages 369-374.

This pre-exposure image is not used aside from the determination of said unknowns. Its quality is indeed insufficient to enable its direct use in conventional mammography diagnosis, due to the low dose used for its acquisition.

The emission parameters indeed directly influence the quality of the image acquired. It is moreover recommended to limit body exposure to X-rays, and will therefore be preferable to acquire images with optimal parameters, so as not to have to perform an additional acquisition and so as to have an image of optimal quality.

The multi-energy method consists of acquiring a plurality of images of the body to be observed, generally following the injection of a contrast product such as iodine, in which said plurality of images are acquired with different energy spectra.

The acquisition of a plurality of images of the same body with different energy spectra enables additional information to be obtained on said body, and thus enables modeling thereof (calculation of thickness charts of the different materials comprising the body). A thickness chart of a given material is an image representing, at each pixel or at each point, the value of the thickness of said material. A total thickness chart of the imaged body can also be obtained, for example by adding together the thickness cards of the different materials comprising said body (otherwise, if the imaged body includes N materials, with thicknesses Tᵢ (I ranging from 1 to N), we can have as unknowns the thicknesses T₁ to T_{N-1} and T, the total thickness of the imaged body, and thus solve the multi-energy modeling).

The dual-energy methods are currently known and used. However, in the multi-energy methods, a plurality of unknowns (corresponding to characteristics of the body; in mammography with the contrast product injection, there are three unknowns: the thickness of the contrast product, the thickness of the glandular tissue, and the thickness of the adipose tissue, with the sum of these three thicknesses being equal to the thickness of the breast) must be determined, in particular owing to the different attenuations of the tissue/material with respect the spectra of the X-rays emitted.

Consequently, in the case of mammography, with dual-energy methods, in which only two spectra are available, it is sought to determine the three unknowns corresponding to the measurement characteristics with the two equations available owing to the two spectra emitted (which normally requires at least three equations, unless a hypothesis is formulated for one of the unknowns). An approximation is then made, by considering one of the unknowns to be constant.

In the case of mammography, it is the thickness of the breast that is considered to be constant, the breast being, in mammography apparatus, compressed between two surfaces. This approximation is however less easily verified at the extremities of the breast due to its round shape, which adversely affects the quality of the modeling of the body.

In the case of a triple-energy method, known for example from the publication “Absorption-edge fluoroscopy using a three-spectrum technique”, by F. Kelcz & C. A. Mistretta, Medical Physics, Vol. 3, No. 3, May/June 1976, the imaging process allows a three-equation system to be solved for three unknowns, thereby avoiding the need for an approximation. In the specific case of this publication, which relates to imaging of the thyroid, the unknowns are thickness of the iodine, thickness of the soft tissue and thickness of the bone.

One way to implement the triple-energy methods would be to acquire a pre-exposure image, in the same way as in conventional mammography, to derive the thickness and composition of the breast therefrom, then to acquire the three images with the optimal spectra corresponding to said thickness and composition of the breast. However, this method involves the acquisition of an additional pre-exposure image in addition to the three images acquired for the triple-energy method. This can increase the examination time of the patient, the compression time of the breast and also the X-ray dose to which the body is subjected.

### SUMMARY OF THE INVENTION

This invention is intended to solve this technical problem, and thus propose a use of the triple-energy method using the pre-exposure image as one of the three images acquired for the triple-energy method.

The invention proposes a process for X-ray imaging of a body using an imaging device including an X-ray emitter operating at different emission spectra and an image sensor, in which said process is characterized in that it includes the steps of: acquiring, by said sensor, a first image resulting from the passage of X-rays emitted with a first emission spectrum through the body; calculating, using calculation means, characteristics of the body based on the first image, and calculating a second emission spectrum and a third emission spectrum based on these characteristics; acquiring, by said sensor, a second image and a third image resulting from the passage of X-rays emitted by the X-ray emitter through the body, with the second emission spectrum and the third emission spectrum, respectively, in which said second and third emission spectra are distinct from one another and distinct from the first spectrum; modeling the body using the calculation means that generate thickness charts for the different materials comprising the body on the basis of the first image, the second image and the third image.

According to a specific embodiment, the modeling step comprises an additional step of: generating a total thickness chart of the body at each point on the basis of the three images acquired, and processing this thickness chart of the body so as to generate a processed version containing only the low frequencies, in which said processed thickness chart of the body is used in the modeling step with the second image and the third image.

According to another specific embodiment, the acquisition of images involves the use of a contrast product, in which said contrast product has a maximum contrast on the images when it is exposed to a specific energy value, called k-edge; said process is characterized in that the second and third image acquisition spectra have average energies respectively above and below the k-edge value of the contrast product, or the converse.

According to a specific embodiment, said imaging process is a process enabling mammography to be performed.

According to another specific embodiment, said energy level of said first image acquisition is between 10 KeV and 30 KeV, and preferably between 15 KeV and 25 KeV, when iodine is used as the contrast product.

According to an alternative of this embodiment, the energy level of the first image is 20 KeV, and the energy levels of the second and third images are respectively 33 KeV and 34 KeV, or the converse when iodine is used as the contrast product.

The invention also relates to a device for X-ray imaging of a body, including an X-ray emitter and an image sensor, in which said device includes: means for acquiring, by said image sensor, a first image resulting from the passage of X-rays emitted according to a first emission spectrum by an X-ray emitter through the body, as well as a second image and a third image resulting from the passage of X-rays emitted according to a second emission spectrum and a third emission spectrum, respectively, through the body by the X-ray emitter, said device is characterized in that it also includes: means for calculating unknowns concerning the body, emission parameters including the second emission spectrum and the third emission spectrum on the basis of the unknowns calculated, during the analysis of said first image, in which said second and third emission spectra are distinct from one another, and distinct from the first spectrum, and said calculation means are also capable of producing, on the basis of the three images acquired, thickness charts of the different materials comprising the body.

According to a specific embodiment, said device also includes: means for processing the total thickness chart of the body so as to generate a processed version of the total thickness chart of the body containing only low frequencies, in which said calculation means are capable of using this processed version of the total thickness chart of the body to produce thickness charts of the different materials comprising the body, and this processed version of the total thickness chart is then combined with the second and third images acquired, so as to generate thickness charts of the different materials comprising the body.

According to another specific embodiment of said device, said X-ray emitter is capable of emitting with photons of which the average energy spectra have values equal to 20 KeV for the acquisition of the first image, and 33 KeV and 34 KeV, respectively, for the acquisition of the second image and the third image, or the converse.

The invention enables a triple-energy modeling to be obtained, thus overcoming the disadvantages and approximations associated with the dual-energy method, while enabling a simple determination of the emission parameters and thus simplified implementation.

### BRIEF DESCRIPTION OF THE DRAWINGS

Other features, objectives and advantages will appear in the following description, which is provided for purely illustrative and non-limiting purposes, and which should be read in view of the appended figures, in which:

FIG. 1 shows a body imaging device performing a triple-energy modeling.

FIG. 2 shows the steps of the triple-energy body imaging process.

FIG. 3 shows the steps of the triple-energy body imaging process including an additional step of processing the (total) thickness chart of the body, generated by combining the three images acquired.

### DETAILED DESCRIPTION OF THE INVENTION

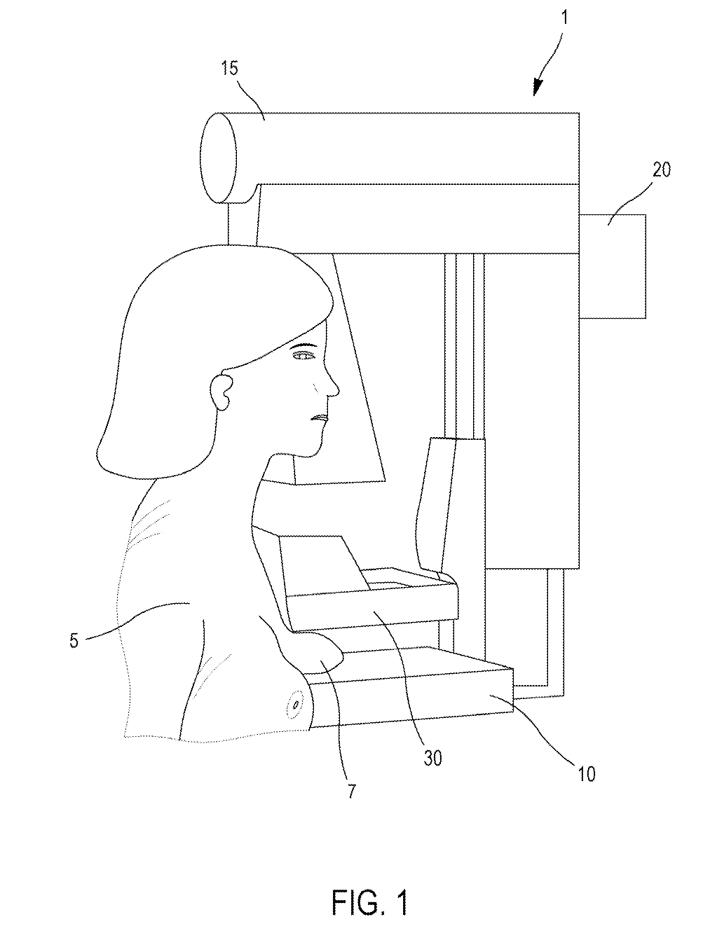

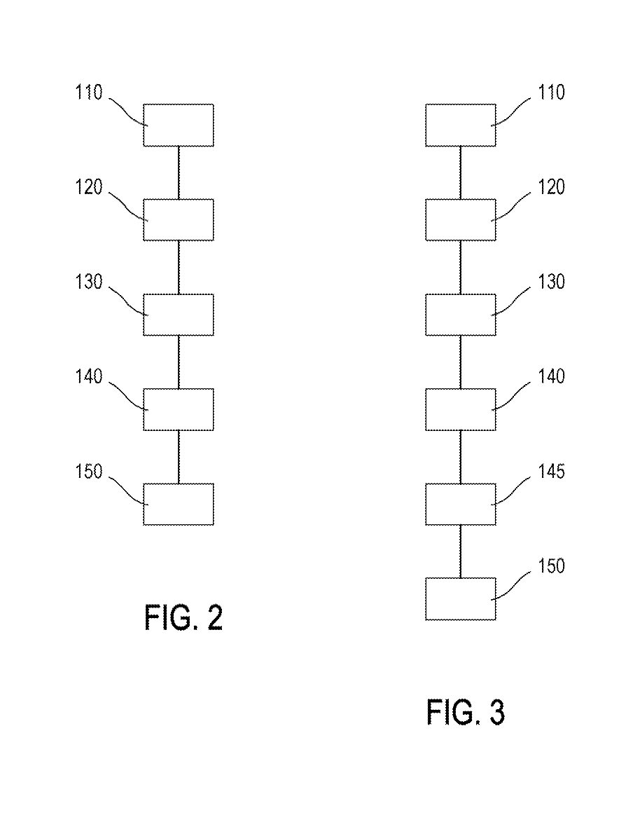

FIG. 1 first shows a body imaging device 1 performing a triple-energy modeling according to the invention, described in greater detail in reference to FIGS. 2 and 3.

The device 1 includes an image sensor 10, an X-ray emitter 15, and calculation means 20.

The image sensor 10 enables acquisition of images obtained via X-ray emission with different spectra by the X-ray emitter 15 on a targeted body 7 of a subject 5.

The calculation means 20 have a number of distinct roles: on the basis of the first image acquired, the calculation of the unknown measurements corresponding to characteristics concerning the targeted body 7; the determination of emission parameters for the second and third images, depending on the unknowns determined previously (these acquisition parameters can consist, for example, of the time of exposure to the X-ray emission spectrum); on the basis of the first, second and third images, the generation of thickness charts for the different material comprising the body by different combinations of the three images acquired.

The device also includes compression means comprised of a breast support combined with the image sensor 10 and a compression pad 30, the role of which is to compress the targeted body 7 so as to facilitate acquisition of images and improve the quality of the images.

Compressing the targeted body in this way enables it to be ensured that the targeted body remains immobile during acquisition of the different images, and also enables detection of the thickness through which the X-rays are to pass in order to acquire the first image. The thickness of the breast is thus estimated by a measurement of the distance between the compression pad 30 and the breast support 10.

FIG. 2 shows the main steps of a triple-energy body imaging process according to the invention.

The subject 5 constituting the body 7 to be observed (for example a breast in the case of mammography) is thus positioned in a body imaging device 1 as shown in FIG. 1, and is capable of being injected with a contrast product.

The first step 110 corresponds to a step of acquisition of a first image. This image is preferably acquired with a very low dose so as to limit irradiation of the patient, but can be acquired regardless of the dose used.

The second step 120 corresponds to a step of determining the emission parameters for second and third images, according to data collected from the acquisition of said first image.

For this determination, the data collected by means of the first acquired image is used to determine unknown factors concerning the targeted body, such as the radiological thickness of the targeted body.

According to a specific embodiment, the process is intended for mammography. In this specific embodiment, the targeted body 7 is the breast of a subject 5. The breast is then conventionally compressed between two elements so as to keep it immobile during the process.

The determination of the emission parameters involves, at the outset, the calculation of unknowns concerning the body 7, namely the thickness and composition of the targeted breast. Once these unknowns have been determined, the emission parameters for the second and third images can be determined according to an optimization method similar to that indicated in “Optimization of Beam Parameters and Iodine Quantification in Dual-Energy Contrast Enhanced Digital Breast Tomosynthesis”, S. Puong, X. Bouchevreau et al., SPIE Medical Imaging 2008, vol. 6913, page. 69130Z, but extended to the triple-energy method.

In X-ray imaging, the determination of emission parameters consists of determining the X-ray emission spectrum, i.e. the energy levels at which the rays will be emitted by an X-ray emitter, as well as the time of exposure of the body to the X-rays.

The optimization of these emission parameters is dependent on the attenuation of the tissues of the body to be viewed.

In the process according to the invention, the first image is acquired with a first spectrum, while the second and third images are acquired, respectively, with a second spectrum and a third spectrum, distinct from one another and distinct from the first spectrum.

According to a specific embodiment, said second and third spectra are energy levels above the energy level of the first spectrum, which is itself very low.

The exact optimal spectra vary with the thickness and composition of the breast; the knowledge of these unknowns will thus enable the emission parameters for the second and third images to be determined. The first image is used to determine the optimal emission parameters for the second and third images.

As an example, in the case in which iodine is used as the contrast product, its k-edge value is 33.2 KeV, the average energy levels of 33 KeV and 34 KeV for the acquisition spectra of the second and third images enable good modeling. These values comply with the configuration cited above; namely, a value slightly below the k-edge value of the contrast product, and a value slightly above the k-edge value of the contrast product.

The third step 130 corresponds to a step of acquisition of the second image, by means of emission parameters determined during step 120, in particular the second energy spectrum.

The fourth step 140 corresponds to a step of acquisition of the third image, by means of emission parameters determined during step 120, in particular the third energy spectrum.

The fifth step 150 corresponds to a modeling step, using the data of the first, second and third images previously acquired, so as to generate thickness charts of the different materials comprising the breast, using a method known to a person skilled in the art.

FIG. 3 shows the imaging process described above, to which an additional step 145 of processing the image is added.

The pre-exposure image is acquired at a very low dose, and consequently has significant quantum noise. An additional step 145 is therefore possible in order to reduce the disturbances resulting from this quantum noise, capable of altering the final modeling.

The additional step 145 then consists of generating a total thickness chart of the body at each point, owing to the solution of the system with three unknowns, corresponding to characteristics of the body. This image is then processed so as to generate a version containing only low frequencies, so as to remove the quantum noise resulting from the low energy level used for the acquisition of the pre-exposure image.

Such a processing enables only the quantum noise to be removed, as the variations in thickness of the body have much lower frequencies than the quantum noise.

It is this processed image that is then used in combination with the two images acquired with optimal emission parameters in order to carry out the triple-energy modeling of the body.

What is claimed is:

1. A method for X-ray imaging of a body using an imaging device comprising an image sensor and an X-ray emitter which operates at different emission spectra, wherein the method comprises:
acquiring, with the image sensor, a first image resulting from the passage through the body of X-rays emitted by the X-ray emitter with a first emission spectrum;
calculating characteristics of the body on the basis of the first image, and calculating a second emission spectrum and a third emission spectrum based on the characteristics of the body, wherein the second and third emission spectra are distinct from one another and distinct from the first emission spectrum;
acquiring, with the image sensor, a second image resulting from the passage through the body of X-rays emitted by the X-ray emitter with the second emission spectrum;
acquiring, with the image sensor, a third image resulting from the passage through the body of X-rays emitted by the X-ray emitter with the third emission spectrum; and
modeling the body by generating thickness charts for different materials comprising the body on the basis of the first image, the second image and the third image.

2. A method according to claim 1, wherein modeling the body further comprises:
generating a total thickness chart of the body at each point on the basis of the first, second and third images;
processing the total thickness chart of the body so as to generate a processed thickness chart of the body containing only low frequencies; and
combining the processed thickness chart with the second image and the third image so as to generate thickness charts of the different materials comprising the body.

3. A method according to claim 1, wherein acquiring a first image, a second image and a third image further comprises:
using a contrast product, wherein the contrast product has a maximum contrast on the images when it is exposed to a specific energy value; and
wherein one of the second and third image acquisition spectra have average energies above or below the specific energy value of the contrast product, and the other of the second and third image acquisition spectra have average energies above or below the specific energy value of the contrast product.

4. A method according to claim 3, wherein the contrast product is iodine.

5. A method according to claim 4, wherein the energy level when acquiring the first image is between about 10 KeV and about 30 KeV.

6. A method according to claim 4, wherein the energy level when acquiring the first image is between about 15 KeV and about 25 KeV.

7. A method according to claim 4, wherein the energy level when acquiring the first image is 20 KeV;
the energy level of one of the second and third image is 33 KeV and the energy level of the other of the second and third image is 34 KeV.

8. A device for X-ray imaging of a body, comprising an X-ray emitter and an image sensor, wherein the device further comprises:
an image sensor configured to acquire a first image, a second image and a third image, the images resulting from the passage through the body of X-rays emitted by the X-ray emitter with a first emission spectrum, a second emission spectrum and a third emission spectrum respectively;
a means for calculating unknown characteristics of the body on the basis of the first image;
a means for calculating the second emission spectrum and the third emission spectrum on the basis of the unknown characteristics, wherein the second and third emission spectra are distinct from one another and distinct from the first emission spectrum; and
a means for calculating thickness charts of the different materials comprising the body on the basis of the first image, the second image and the third image.

9. The device according to claim 8, further comprising:
a means for processing the total thickness chart of the body so as to generate a processed thickness chart of the body containing only low frequencies;
wherein the calculation means uses the processed thickness chart of the body to produce thickness charts of the different materials comprising the body; and
wherein the calculation means further combines the processed thickness chart with the second image and the third image so as to generate thickness charts of the different materials comprising the body.

10. The device according to claim 8, wherein the X-ray emitter emits with photons of which the average energy spectra have values equal to about 20 KeV for the acquisition of the first image, about 33 KeV for the acquisition of the second image and about 34 KeV, for the acquisition of the third image.
